(19) United States
(12) Patent Application Publication
(10) Pub. No.: US 2013/0072412 A1
(43) Pub. Date: Mar. 21, 2013

(54) Detergent Composition

(71) Applicants: Claudia Schmaelzle, Ludwigshafen (DE); Kai Heppert, Ludwigshafen (DE); Jörg Pflug, Ludwigshafen (DE)

(72) Inventors: Claudia Schmaelzle, Ludwigshafen (DE); Kai Heppert, Ludwigshafen (DE); Jörg Pflug, Ludwigshafen (DE)

(73) Assignee: Reckitt Benckiser N.V., WT Hoofddorp (NL)

(21) Appl. No.: 13/583,382

(22) PCT Filed: Mar. 9, 2011
(86) PCT No.: PCT/GB2011/050461

§ 371 Date: Dec. 11, 2012

(30) Foreign Application Priority Data
Mar. 9, 2010 (GB) 1003892.5

(51) Int. Cl. C11D 3/395; C11D 17/00

(52) U.S. Cl. CPC C11D 3/395; C11D 17/00
USPC 510/220; 252/186.42; 510/108; 510/218

(57) ABSTRACT

The present invention provides easy to handle, stable bleach material particle comprising a co-granulate of a bleach material, a water soluble binder and a disintegrant. It also provides easy to handle, stable shaped bodies comprising bleach material, a binder and a disintegrant where at least the bleach material and the binder are preferably co-granulated together. Detergent compositions comprising the bleach material particle or the shaped body are also provided. The products of the invention exhibit good solubility characteristics and bleachable stain removal performance.

### TECHNICAL FIELD

The present invention relates to particulate material and a shaped body comprising a bleach material, a binder and a disintegrant and to compositions comprising the same. In particular the present invention relates to such particles for use in dishwashing and to dishwashing compositions. It is preferred that the bleach material comprises an organic peracid including derivatives, salts and mixtures thereof and especially perbenzoic acid and peroxy-carboxylic acids. An especially preferred bleach material is 6-phthalimidoperoxyhexanoic acid (PAP). The particles exhibit good stability of the bleach as well as good solubility characteristics. Furthermore good bleaching effects are provided on bleachable stains such as tea stains.

### BACKGROUND AND PRIOR ART

It is well known in the detergent art to formulate bleaching materials in particulate form as this considered a convenient form for inclusion in many detergent compositions.

In order to obtain good cleaning performance on bleach-able stains, e.g. tea, it is desirable to include a bleach material in detergent compositions which are to be used to remove such stains. In dishwashing, especially automatic dishwashing it is well recognised that performance on bleachable stains is one of the key attributes by which consumers assess the effectiveness of a detergent compositions. However, it is well known in the art that the presence of a bleach material in a detergent composition can lead to instability of the composition especially when bleach-sensitive ingredients such as enzymes and perfumes are present. Furthermore the bleach material is generally susceptible to stability problems e.g. when in contact with moisture and/or above ambient temperatures which can typically result in a loss of performance of the bleach material.

It has been attempted to address the above problems of stability of the bleaching material/other ingredients and address the resultant loss in performance of the detergent composition by producing granules comprising the bleaching material and coating them with a coating material.

EP-A-1,735,422 and EP-A-1,735,423 discloses a coated bleaching agent particle consisting of a core containing a bleaching active ingredient, especially a peroxocarboxylic acid, with a coat of water soluble material surrounding this core (such as PVOH).

EP-A-1,633,468 discloses a method for preparing capsules containing at least one imidoperoxycarboxylic acid by applying an inorganic salt onto the at least one imidoperoxycarboxylic acid in particulate form so that the salt forms a capsule shell around the acid.

EP-A-1,633,471 discloses a method for preparing multi-layer capsules containing at least one peroxocarboxylic acid (especially imidoperoxycarboxylic acid) by applying at least two different coating layers each based on at least one polyelectrolyte and/or ionic surfactant.

WO 2004/081161 discloses bleach (PAP) encapsulated with a water soluble coating such as gelatin. This bleach containing capsule is disclosed in combination with a liquid composition inside a water soluble outer container.

Encapsulating bleach materials to reduce interaction with bleach sensitive materials so as to maintain performance on bleachable stains provides advantages for stability and performance but can still be improved upon. In particular the dissolution time of the particles or shaped bodies comprising the bleach materials could still be improved, especially when an organic peracid bleach is used such as PAP, and this is desirable as it provides for a longer contact time between the bleach material and the bleachable stains thus providing the potential for improved performance.

It has also been found that bleaches, especially organic peracids such as perbenzoic acid and peroxocarboxylic acid bleaches can be difficult to produce in granular form (which is a preferred format for many detergent applications) as they are often commercially available as a powder having a relatively small particle size which can be associated with handling difficulties on an industrial scale and difficult to form into particles or shaped bodies. However, these bleach materials are effective at relatively low temperatures and are especially preferred for detergent applications on environmental and cost considerations as they can be used without the need for additional bleach catalysts or bleach activators. Therefore there is also a need in the art to provide effective methods of handling bleach materials in particulate form and also for producing detergent compositions therewith which can be applied on an industrial scale.

It is therefore an object of the present invention to address one or more of the above-mentioned problems.

In particular, it is an object of the present invention to provide particulate material and shaped bodies comprising a bleach material which show good stability and performance of the bleach material coupled with good dissolution properties thereof.

It is a further object of the present invention to provide bleach material which can be readily handled on an industrial scale and which can readily be formed into shaped bodies. In particular such materials which exhibit good solubility characteristics when in use in a washing process are desired.

### Statement of Invention

It has surprisingly been found that one or more of the above problems are addressed by the present invention.

Thus according to the present invention there is provided a bleach material particle comprising a co-granulate of a bleach material, a water soluble binder and a disintegrant.

According to a second aspect of the invention there is provided a shaped body comprising bleach material, a water soluble binder and a disintegrant.

It is especially preferred that the shaped body comprises bleach material particles of the first aspect of the invention. It is also preferred that the shaped body comprises a co-granulate of the bleach material and the water soluble binder in an admixture with the disintegrant.

Preferably the shaped body is formed by a compaction process or by injection moulding.

For the bleach material particle or the shaped body according to the first and second aspect of the invention respectively it is preferred that the bleach material comprises at least one inorganic peroxide, organic peracid or chlorine based bleach including derivatives and salts thereof or mixtures thereof, with organic peracid including derivatives and salts and mixtures thereof being most preferred. It is especially preferred that the at least one organic peracid comprises perbenzoic acid and/or at least one peroxycarboxylic acid. It is most preferred that the peroxycarboxylic acid comprises mono- or diperoxyphthalic acid, 2-octyldiperoxysuccinic acid, diperoxydodecanedicarboxylic acid, diperoxyazelaic acid, 6-phthalimidoperhexanoic acid (PAP) or imidoperoxycarboxylic acid or the derivatives and salts and mixtures thereof. PAP is the most preferred bleach material according to the present invention.

According to all aspects of the invention it is preferred that the weight ratio of the active amount of the bleach material to the water soluble binder is in the range of from 10:1 to 1:1. It is also preferred according to all aspects of the invention that the weight ratio of the active amount of the bleach material to the disintegrant is in the range of from 30:1 to 2:1.

For all aspects of the invention it is preferred that the water soluble binder has a higher degree of water solubility at 20° C. than the bleach material. Organic binders are preferred and sugar based binders have been found to be effective. In particular the material known as ‘Isomalt’ which is a mixture of 6-O-a-D-Glucopyranosyl-D-sorbitol (1,6-GPS) and 1-O-a-D-Glucopyranosyl-D-mannitol dehydrate (1,1-GPM) has been found to be very effective as the water soluble binder and is especially preferred.

It is preferred for all aspects of the invention that the disintegrant is an organic material, especially a saccharide based material such as a polysaccharide. Soy polysaccharides have been found to be very advantageous according the present invention and these are thus preferred types of disintergrants.

According to a third aspect of the invention there is provided a detergent composition comprising the bleach material particle of the first aspect of the invention or the shaped body according to the second aspect of the invention.

Preferably the composition is dishwashing composition and in particular an automatic dishwashing detergent composition.

According to a fourth aspect there is provided the use of the bleach material particle according to the first aspect or of the shaped body according to the second aspect or of the detergent composition according to the third second aspect in a washing operation, especially in an automatic dishwashing operation.

Surprisingly, it has been found that bleach material particles and shaped bodies according to the present invention exhibits good stability, performance on bleachable stains and dissolution characteristics. It has also been found that it is a convenient way to handle difficult materials such as peroxycarboxylic acids on an industrial scale. It has also been found that by using organic per-acid bleaches in a shaped body it is rendered more suitable for coating than in its uncompressed state and this also increases the stability of the bleach as the coating provides an extra layer of protection for the bleach.

Unless stated otherwise, all amounts herein are given as the percentage by weight of active ingredient based upon the weight of the total composition or the total particle as the context requires.

The term λ substantially free of as used herein means less than 0.5% wt of the material in question based on the total weight of that material in the compositor particle or shaped body in question.

The term at least partially enveloped’ as used herein means that the water soluble or water dispersible packaging material at least partly surrounds the bleaching composition.

The term ‘co-granulate’ as used herein includes any particle wherein the stated ingredients are held together in that particle. This includes particles produced by agglomeration, granulation, fluidized bed and spray-drying.

### DETAILED DESCRIPTION

The present invention will now be described in further detail.

i) Bleach Material Particle

According to the first aspect of the invention there is provided a bleach material particle comprising a co-granulate of a bleach material, a water soluble binder and a disintegrant.

The bleach material particles may be produced by any suitable co-granulation technique. Such techniques are well known in the art and do not require further description here but include agglomeration, granulation, fluidized bed and spray-drying. It is within the ability of the person skilled in the art to be able to adjust the co-granulation technique parameters to produce the co-granulates of the first aspect of the invention.

The bleach material particle may be in the form of a powder or granular material depending upon its particle size. The bleach material particles of the invention may be of any suitable size but will preferably be in the range of from 20 microns to 2000 microns (weight average mean size), more preferably 50 microns to 1500 microns, most preferably 100 microns to 900 microns, such as 200 microns to 800 microns.

The weight ratio of the bleach material, water soluble binder and disintegrant in the bleach material particle is discussed below in section vi.

It is especially preferred that the bleach material comprises from 40-90% by weight of the bleach material particles, preferably from 50-85% by weight such as from 55-80% by weight. It is especially preferred that the water soluble binder comprises from 10-40% by weight of the bleach material particles, preferably 15-35% by weight such as 20-30% by weight. It is especially preferred that the disintegrant comprises from 2-15% by weight of the bleach material particles, preferably from 3-10% by weight such as from 4-8% by weight.

ii) Shaped Body

The shaped body of the second aspect of the invention is preferably formed from a liquid, gel, slurry or a powder/granulate material. The shaped body may be formed of compressed powder/granulates or cast, injection moulded or extruded material.

The shaped body may be in the form of a tablet, pellet, rod, ball or lozenge. For the avoidance of doubt the term ̂tablet’ as used herein includes pills.

Tablets produced by compression or injection moulding are preferred according to the present invention, especially tablets produced by a compression process. Any suitable conventional method may be used to produce the shaped body e.g. tabletting, injection moulding or casting.

These processes are well know to the person skilled in the art and thus do not need to be described further

Where the shaped body is a tablet produced by a composition process it has been found that especially good suits can be obtained.

The shaped body may be produced from;
1) the bleach material particles of the first aspect of the present invention (optionally with one or more of the optional ingredients below admixed with the particles prior to the shape body being formed), or
2) firstly admix the bleach material, the water soluble binder and the disintegrant together in non-cogranulated form, optionally add one or more optional ingredients as detailed below, and form the shaped body from the resultant admixture, or
3) mix a co-granulate of the bleach material and the water soluble binder add the disintegrant and if desired one or more of the optional ingredients below and to form the shaped body from the resultant mixture.

The first and third options are especially preferred according to the invention.

In all of the forgoing options the shaped body is preferably formed by compaction or by injection moulding.

One advantage of the present invention is that the incorporation of the specified binder and the disintegrant provides for improved dissolution times of the shaped bodies as it helps to break up the shaped body when used in the washing operation.

It has been further found that when the water soluble and the disintegrant of the invention are used with relatively low compaction pressures this additionally leads to further increased solubility for the shaped body as it is not so densely compacted and thus water is better able to ingress into the shaped body leading to faster dissolution times.

It is preferred according to the present invention that the shaped bodies are produced by a compaction method wherein the mean compression force (kN) applied by the punches of the tabletting press during the compaction method is in the range of from 0.5 kN to 5 kN, more preferably from 0.7 to 3 kN, such as 1.0 to 2.5 kN. This is combination with the presence of the water soluble binder and disintegrant has been found to be very effective in providing good dissolution times for the shaped body which in turn aids the performance on bleachable stains.

The shaped body preferably has a hardness of less than 150N (as measured on an Eweka Hardness testing apparatus TBH 220 using a pin of diameter 8 mm and length 14 mm, following the published method: “Direktmessung ohne Vorgabe” which is a measurement with constant speed of: 0.5 mm/s) in order to keep the dissolution times as low as possible. Most preferably the hardness is in the range of from 75N to 130N, more preferably 85N to 120N.

It is preferred that the bleach material comprises from 10-70% by weight of the shaped body, preferably from 20-65% by weight such as from 30-60% by weight. It is especially preferred that the water soluble binder comprises from 2-40% by weight of the shaped body, preferably 5-35% by weight such as 10-30% by weight. It is preferred that the disintegrant comprises from 2-15% by weight of the shaped body, preferably from 3-10% by weight such as from 4-8% by weight.

The shaped body may comprise one or more of the optional ingredients as detailed below.

The shaped body of the invention may be used alone in a detergent application, e.g. as a detergent tablet or it may be used in combination with another part of a detergent composition e.g. a shaped body in combination with a liquid held inside an outer water soluble wrapper to produce a detergent composition. The shaped body may be held inside a water soluble or water dispersible wrapper as described below for the detergent composition and the comments under section vii below apply equally here. The shaped body may be used as a unit dose product as described herein below.

The comments herein to the bleach material, the water soluble binder and the disintegrant apply equally to all aspects of the invention.

iii) Bleach Material

The bleach material may be selected from any conventional bleach material used in detergent compositions. The bleach material preferably comprises at least one inorganic peroxide or organic peracid or a chlorine based bleach including derivatives and salts thereof or mixtures thereof. Most preferred according to the invention are organic peracids and their derivatives/salts.

If at least one inorganic peroxide is used as the bleach material it preferably comprises a percarbonate, perborate and persulphate and/or hydrogen peroxide including derivatives and salts thereof and mixtures thereof. The sodium and potassium salts of these inorganic peroxides being most preferred, especially the sodium salts. Sodium percarbonate and sodium perborate are most preferred, especially sodium percarbonate.

It is especially preferred according to the present invention that the bleach material comprises at least one organic peracid including derivatives and salts and mixtures thereof. These bleach materials are effective at relatively low temperatures, typically around 30° C. and so do not require the use of a bleach activator or bleach catalyst to boost the bleaching performance. This makes these bleach materials especially preferred for detergent applications on environmental and cost considerations.

Organic peracids suitable according for use in the present invention include all organic peracids traditionally used as bleaches in detergent compositions. Preferred examples include perbenzoic acid and peroxycarboxylic acids especially mono- or diperoxyphthalic acid, 2-octyldiperoxysuccinic acid, diperoxydodecanedicarboxylic acid, diperoxyazelaic acid, 6-phthalimidoperhexanoic acid (PAP) and imidoperoxycarboxylic acid and the derivatives and salts and mixtures thereof. Especially preferred is 6-phthalimidoperhexanoic acid (PAPJ and the derivatives and salts and mixtures thereof.

The bleach material may be used in a pure form but it is usually commercially available as a raw material which is a mixture of the bleach active material with carrier materials or other auxiliaries such as suitable compatible materials such as stabilisers for the bleach and fillers. Suitable stabilising materials include materials which are capable of taking up water, e.g. as water of crystallisation, such as sulphates.

iv) Water Soluble Binder

The bleach material particle and the shaped body of the invention both comprise a water soluble binder. The binder helps to improve the flow properties of the bleach material particle and acts as a binder to help produce the shaped body of the invention.

Without wishing to be bound by theory it is believed that the water soluble binder helps decrease the dissolution time of the bleach material particle and the shaped body. Any suitable water binder may be used according to the present invention however it is especially preferred that the water soluble binder has a higher degree of water solubility at 20° C. than the bleach material.

Organic binders are preferred according to the invention and sugar based binders have been found to be effective. In particular the material known as ‘Isomalt’ (available from BENEO-palatinit) as Galen IQ™ 720, Galen IQ™ 721, Galen IQ™ 800 and Galen IQ™ 820) which is a mixture of 6-O-a-D-Glucopyranosyl-D-sorbitol (1,6-GPS) and 1-O-a-D-Glucopyranosyl-D-mannitol dehydrate (1,1-GPM) has been found to be very effective as the water soluble binder. It is available as mixtures of (1,6-GPS) to (1,1-GPM) in a weight ratio of 1:1 to 3:1.

It is preferred that the bleach material and the water soluble binder are used in a co-granulated form in the bleach material particle and in the shaped body.

By the term ‘water soluble’ as used herein is meant that at least 5 g of the binder dissolves in 100 g water at 20° C. (with agitation). Preferably at least 10 g of the binder dissolves in water at 20° C.

v) Disintegrant

Any suitable disintegrant can be included in the bleach material particle or in the shaped body.

However it is preferred that the disintegrant is an organic material and it is especially preferred that it comprises a saccharide based material such as a polysaccharide. Soy polysaccharides have been found to be very advantageous according the present invention and these are thus preferred types of disintergrants.

It is also possible to include cellulose based disintergrants in addition to, or as an alternative to, the saccharide based disintergrants.

vi) Ratio of Bleach Material, Water Soluble Binder and Disintergrants

Generally according to all aspects of the present invention the bleach material will be present in a greater percentage by weight than the water soluble binder or the disintegrant (based on active ingredient). It is preferred that the weight ratio of the active amount of the bleach material to the water soluble binder is in the range of from 10:1 to 1:1, more preferably 7:1 to 1.25:1 and especially 5:1 to 1.5:1.

The disintegrant is typically present according to all aspects of the invention in a lesser percentage by weight than either the bleach material or the water soluble binder. It is preferred that the weight ratio of the active amount of the bleach material to the disintegrant is in the range of from 30:1 to 2:1, more preferably 20:1 to 5:1 and especially 15:1 to 7.5:1. It is preferred that the weight ratio of the water soluble binder to the disintegrant is in the range of from 10:1 to 1.5:1, more preferably 7:1 to 2:1 and especially 5:1 to 2.5:1.

It is preferred according to the present invention that the bleach material comprises an organic peracid, the water soluble binder comprises sugar based binder and the disintegrant comprises a polysaccharide. It is especially preferred that the bleach material comprises PAP, the water soluble binder comprises a mixture of 6-0-a-D-Glucopyranosyl-D-sorbitol (1,6-GPS) and 1-O-a-D-Glucopyranosyl-D-mannitol dehydrate (1,1-GPM) and the disintegrant comprises a soy polysaccharide. It is preferred that these ingredients are used together in the ratios given herein.

vii) Detergent Compositions

The detergent compositions and the shaped bodies of the invention may be used in principle for any cleaning operation. However, it is preferred that they are laundry detergents or hard surface cleaning compositions for example dishwashing detergents, floor cleaners or surface cleaners. It is most preferred that the hard surface cleaning compositions are dishwashing compositions and in particular automatic dishwashing compositions.

The detergent composition of the third aspect of the invention may be in any suitable physical form. If the detergent composition comprises the bleach material particle of the first aspect of the invention it may be in a liquid, gel, slurry, powder or shaped body form. The detergent compositions may be produced by any suitable method.

The detergent compositions and/or the shaped bodies may be formulated as a unit dose detergent composition i.e. designed to be used as a single portion of detergent composition in a single washing operation. Of course, one or more of such single portions may be used in a cleaning operation if desired.

If the shaped body/detergent formulation is intended as a unit dose product it may comprise a water soluble or water dispersible package of water soluble or water dispersible packaging material with the composition/shaped body being at least partly enveloped by the packaging material. It is preferred that the composition/shaped body is fully enveloped by the water soluble or water dispersible packaging material. Such packages are well known in the art, see for example and may be of any suitable form and shape including that of a pre-formed container, preferably a self-supporting container see for example WO 09/034355 and WO 01/36290. The package may be formed by any suitable method, for example the method described in WO 2004/081161 which method is incorporated by reference herein. Any suitable conventional method may be used to form the water soluble or water dispersible package, e.g. thermoforming and/or vacuum forming or injection moulding although the latter is less preferred.

Typically the detergent composition comprises the bleach material particle of the first aspect of the invention or the shaped body of the second aspect of the invention in an amount by weight of from 1% to 60% wt, preferably from 5% to 50% wt such as from 10% to 45% wt based on the total weight of the detergent composition.

The shaped body may comprise one or more of the optional ingredients as detailed below.

viii) Coating

The bleach material particle and the shaped body may if desired have an exterior coating to protect the bleach material.

Any suitable water soluble or water dispersible coating materials may be used and suitable examples are well known in the art. It is preferred that a coating material is used and any suitable method may be used to apply the coating.

Suitable coating materials include water soluble polymers (such as polyvinyl alcohol), non-ionic surfactants, anionic polyelectrolytes and cationic polyelectrolytes.

When a coating is applied to the particle it preferably is applied in an amount of 5% to 50% wt based on the total weight of the particle, more preferably 10% to 40%, most preferably 15 to 35% wt. When a coating is applied to the shaped body it preferably is applied in an amount of 2% to 30% wt based on the total weight of the shaped body, more preferably 5% to 25%, most preferably 10 to 20% wt.

ix) Optional Ingredients

The shaped body of the second aspect of the invention and the detergent composition of the third aspect of the invention may comprise one or more of the optional ingredients below in the conventional amounts. All amounts for the optional ingredients are referred to as the amount of the optional ingredient based on the total weight of the shaped body or detergent composition.

It is possible to include bleach sensitive material in the shaped body or detergent compositions although these will typically be protected from the bleach material in some way. This may be achieved by them being placed in a different part of the shaped body/composition or by either the bleach material or the bleach sensitive material being encapsulated to prevent interaction between these incompatible ingredients.

Bleach sensitive ingredients include enzymes and any type of enzyme typically used in detergent compositions may be used. It is preferred that the enzyme is selected from proteases, lipases, amylases, cellulases and peroxidases, with proteases and amylases, especially proteases being most preferred. It is most preferred that protease and/or amylase enzymes are included in the compositions according to the invention as such enzymes are especially effective for example in dishwashing detergent compositions. Any suitable species of these enzymes may be used as desired.

The bleach sensitive ingredient may also comprise a perfume or dye. Any type of perfume or dye may be used.

The bleach sensitive material may preferably comprise one or more bleach activators or bleach catalysts depending upon the nature of the bleaching compound. Any suitable bleach activator may be included for example TAED if this is desired for the activation of the bleach material.

Any suitable bleach catalyst may be used for example manganese acetate or dinuclear manganese complexes such as those described in EP-A-1,741,774. The organic peracids such as perbenzoic acid and peroxycarboxylic acids e.g. PAP do not require the use of a bleach activator or catalyst as these bleaches are active at relatively low temperatures such as about 30° C. and this contributes to such bleach materials being especially preferred according to the present invention.

Surfactant may also be included in the shaped body or detergent composition and any of nonionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred according to the present invention.

Non-ionic surfactants are especially preferred according to the present invention, especially for automatic dishwashing compositions. For laundry and cleaning applications (excluding automatic dishwashing) other surfactants such as anionic surfactants are preferably included and suitable types are well known in the art.

A preferred class of nonionic surfactants is ethoxylated non-ionic surfactants prepared by the reaction of a mono-hydroxyalkanol or alkylphenol with 6 to 20 carbon atoms. Preferably the surfactants have at least 12 moles particularly preferred at least 16 moles, and still more preferred at least 20 moles, such as at least 25 moles o ethylene oxide per mole of alcohol or alkylphenol.

Particularly preferred non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant

Surfactants which are ethoxylated mono-hydroxyalkanols or alkylphenols, which additionally comprises poly-oxyethylene-polyoxypropylene block copolymer units may b used. The alcohol or alkylphenol portion of such surfactants constitutes more than 30%, preferably more than 50%, more preferably more than 70% by weight of the over all molecular weight of the non-ionic surfactant.

Another class of suitable non-ionic surfactants includes reverse block copolymers of polyoxyethylene and poly-oxypropylene and block copolymers of polyoxyethylene and polyoxypropylene initiated with trimethylolpropane.

Another preferred class of nonionic surfactant can be de scribed by the formula:

R¹O[CH₂CH(CH₃)O]ₓ[CH₂CH₂O]_{y}[CH₂CH (OH)R²]

where R¹ represents a linear or branched chain aliphatic hydrocarbon group with 4-18 carbon atoms or mixtures

thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]ₓ[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³H, methyl or ethyl is particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R═H) or propyl-3ene oxide (R³=methyl) units which can be used in every single order for instance (PO) (EO) (EO), (EO) (PO) (EO), (EO) (EO) (PO), (EO) (EO) (EO), (PO) (EO) (PO), (PO) (PO) (EO) and (PO) (PO) (PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]ₓCH₂CH(OH)CH₂OR²

The use of mixtures of different nonionic surfactants is suitable in the context of the present invention for instance mixtures of alkoxylated alcohols and hydroxy group containing alkoxylated alcohols.

Other suitable surfactants are disclosed in WO 95/01416, to the contents of which express reference is hereby made.

Preferably the non-ionic surfactants are present in the shaped body or the detergent composition in an amount of from 0.1% wt to 20% wt, more preferably 1% wt to 15% wt, such as 2 to 10% wt based on the total weight of the shaped body or detergent composition.

A builder may also be included and it may be either a phosphorous-containing builder or a phosphorous-free builder as desired.

If phosphorous-containing builders are also to be used it is preferred that mono-phosphates, di-phosphates, tri-polyphosphates or oligomeric-polyphosphates are used. The alkali metal salts of these compounds are preferred, in particular the sodium salts. An especially preferred builder is sodium tripolyphosphate (STPP). Conventional amounts of the phosphorous-containing builders may be used typically in the range of from 15% wt to 60% wt, such as 20 or 25% wt to 40 or 50% wt.

If a phosphorous-free builder is included it is preferably chosen from amino acid based compounds and/or succinate based compounds. The terms succinate based compound’ and ‘succinic acid based compound’ are used interchangeably herein. Conventional amounts of the amino acid based compound and/or succinate based compound may be used typically in the range of from 20% wt to 80% wt, such as 25 or 30% wt to 60 or 70% wt.

Preferred examples of amino acid based compounds which may be used are MGDA (methyl-glycine-diacetic acid, and salts and derivatives thereof) and GLDA (glutamic-N, N-diacetic acid and salts and derivatives thereof). Other suitable builders are described in U.S. Pat. No. 6,426,229 which are incorporated by reference herein. Particular suitable builders include; for example, aspartic acid-N-monoacetic acid (ASMA), aspartic acid-N, -diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), a-alanine-N,N-diacetic acid (a-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N, -diacetic acid (SMDA) and alkali metal salts or ammonium salts thereof.

Further preferred succinate compounds are described in U.S. Pat. No. 5,977,053 and have the formula;

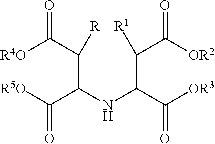

in which R, R¹, independently of one another, denote H or OH, R², R³, R⁴, R⁵, independently of one another, denote a cation, hydrogen, alkali metal ions and ammonium ions, ammonium ions having the general formula R⁶ R⁷ R⁸ R⁹ N+ and R⁶, R⁷, R⁸, R⁹, independently of one another, denoting hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts.

It is especially preferred according to the present invention that the builder comprises methyl-glycine-diacetic acid, glutamic-N, -diacetic acid, tetrasodium imminosuccinate, or (hydroxy) iminodisuccinic acid and salts or derivatives thereof.

The phosphorous-free builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

Preferably the total amount of builder present is an amount of at least 20 wt %, and most preferably at least 25 wt %, preferably in an amount of up to 70 wt %, preferably up to 65 t %, more preferably up to 60 wt %. The actual amount used in the compositions will depend upon the nature of the builder used. If desired a combination of phosphorous-containing and phosphorous-free builders may be used.

The shaped body and detergent compositions may optionally further comprise a secondary builder (or cobuilder).

Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred. A polymeric polycarboxylic acid is the homopolymer of acrylic acid. Other suitable secondary builders are disclosed in WO 95/01416, to the contents of which express reference is hereby made.

Preferably the total amount of co-builder present is an amount of up to 10 wt %, preferably at least 5 wt % . The actual amount used in the compositions will depend upon the nature of the builder used.

The shaped body or detergent compositions may also comprise a source of acidity or a source of alkalinity, to obtain the desired pH, on dissolution, especially if the composition is to be used in an automatic dishwashing application. Preferred silicates are sodium silicates such as sodium disilicate, sodium metasilicate and crystalline phyllosilicates. A source of acidity may suitably be any suitable acidic compound for example a polycarboxylic acid. For example a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity.

The shaped body and detergent compositions may comprise one or more anti-corrosion agents, especially when the detergent compositions are for use in automatic dishwashing operations. These anti-corrosion agents may provide benefits against corrosion of glass and/or metal and the term encompasses agents that are intended to prevent or reduce the tarnishing of non-ferrous metals, in particular of silver and copper.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, bismuth, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of: MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, COSO₄, Co(NO₃)₂, zinc acetate, zinc sulphate and Ce(NO₃)₃. Any suitable source of multivalent ions may be used, with the source preferably being chosen from sulphates, carbonates, acetates, gluconates and metal-protein compounds. Zinc salts are specially preferred corrosion inhibitors.

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain Ci-20 alkyl groups and hydroxyl, thio, phenyl or halogen such as fluorine, chlorine, bromine and iodine. A preferred substituted benzotriazole is tolyltriazole.

Any conventional amount of the anti-corrosion agents may be included. However, it is preferred that they are present in an total amount of from 0.01% wt to 5% wt, preferably 0.05% wt to 3% wt, more preferably 0.1 to 2.5% wt, such as 0.2% wt to 2% wt based on the total weight.

Polymers intended to improve the cleaning performance of the shaped bodies or detergent compositions may also be included therein. For example sulphonated polymers may be used. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof.

Other suitable sulfonated monomers for incorporation in sulfonated (co) polymers are 2-acrylamido-2-methyl-1-propanesulphonic acid, 2-methacrylamido-2-methyl-1-propane sulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541.

When a sulfonated polymer is present, it is preferably present in an amount of at least 0.1 wt %, preferably at least 0.5 wt %, more preferably at least 1 wt %, and most preferably at least 3 wt %, up to 40 wt %, preferably up to 25 wt %, more preferably up to 15 wt %, and most preferably up to 10 wt %.

The shaped body and detergent composition may also comprise one or more foam control agents. Suitable foam control agents for this purpose are all those conventionally used in this field, such as, for example, silicones and their derivatives and paraffin oil. The foam control agents are preferably present in amounts of 0.5% by weight or less.

The shaped body and detergent compositions may also comprise minor, conventional, amounts of preservatives.

The invention is further described with reference to the following non-limiting Examples. Further examples within the scope of the invention will be apparent to the person skilled in the art.

### EXAMPLES

### Examples 1, 2 and 3

Three different types of particles were prepared comprising;

1) 6-phthalimidoperoxyhexanoic acid (PAP) as the bleach material available as Eureco™ WM1 from Solvay Chemicals and comprising 70-75% wt active PAP.

2) a mixture of 6-O-a-D-Glucopyranosyl-D-sorbitol (1,6-GPS) and 1-0-A-d-Glucopyranosyl-D-mannitol dehydrate (1,1-GPM) as the binder material known as ‘Isomalt’ and available from BENEO-Palatinit. Either GalenlQ™ 800 or GalenlQ™ 720 are used m these examples, and

3) a soy polysaccharide as the disintegrant available as Emcosoy STS IP from J. Rettenmaier & Sohne GmbH.

Examples 1, 2 and 3 were prepared by firstly co-granulating the bleach material and the binder material together to form a co-granulate of these two materials and then post-adding thereto the disintegrant to produce a particulate mixture having the overall formulation as shown in Table 1 below. All percentages are by weight based on the amount of raw material used (not active weight for the PAP) and the total weight of the resultant particulate mixture.

TABLE 1

| | Ex 1 | Ex 2 | Ex 3 |
|---|---|---|---|
| Raw materials | % wt | % wt | % wt |
| 6-phthalimido- | 65.0 | 65.0 | 75.0 |
| peroxyhexanoic | | | |
| acid (PAP); | | | |
| Eureco ™ WM1 | | | |
| Isomalt- | 30.0 | | 20.0 |
| GalenlQ ™ 800 | | | |
| Isomalt | | 30.0 | |
| GalenlQ ™ 720 | | | |
| Emcosoy STS IP | 5.0 | 5.0 | 5.0 |

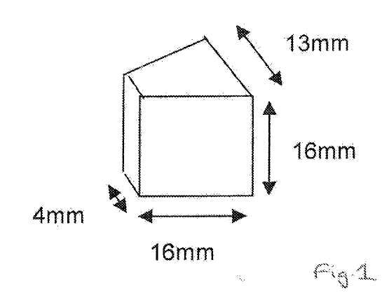

The resultant particulate mixtures were formed into flat topped wedge shaped tablets being of a six sided parallelepiped configuration. The apex of the wedge is rectangular with dimensions of 4 mm×16 mm, the back face is a square of 16 mm×16 mm, the base is rectangular with dimensions of 13 mm×16 mm and the remaining three sides extend from the apex down to the base (as shown in FIG. 1) and having a weight of approximately 2 g. The tablets for each example were produced in a Kilian SP 300 tablet press. The compression force of the upper and lower punches (in mean kN) used for each example and the mean compression force (kN) is given in table 2 alone with the average hardness (N) of the tablets of each example. The hardness of the tablets was measured according to the method described in the description.

TABLE 2

| Raw materials | Ex 1 | Ex 2 | Ex 3 |
|---|---|---|---|
| Compression | 1.6 | 1.3 | 1.9 |
| force of upper | | | |
| punch (kN) mean | | | |
| Compression | 1.4 | 1.1 | 1.5 |
| force of lower | | | |
| punch (kN) mean | | | |
| Compression | 1.5 | 1.2 | 1.7 |
| force (kN) mean | | | |
| Hardness (N) | 108 | 92 | 113 |
| mean | | | |

The tablets produced as above were stored at 40° C. and 75% relative humidity in glass bottles with the lid left open to the atmosphere and the time taken for the tablets to dissolve in the Erweka 40° C. disintegration test was measured on a Erweka ZT 504 machine at 40° C. using 30 strokes/min; height of stroke of 55 mm. The results are given in Table 3 (mean values in minutes and seconds).

TABLE 3

| Disintegration | | | |
|---|---|---|---|
| times | Ex 1 | Ex 2 | Ex 3 |
| O weeks | 4.00 | 2.00 | 4.30 |
| 3 weeks | 2.55 | 1.55 | 3.35 |
| 6 weeks | 2.25 | 2.10 | 4.00 |
| 9 weeks | 3.30 | 2.30 | 4.05 |

1. A bleach material particle comprising a co-granulate of: a bleach material, a water soluble binder and a disintegrant.

2. A shaped body comprising bleach material, a water soluble binder and a disintegrant.

3. A shaped body according to claim 2, wherein the shaped body comprises the bleach material, the water soluble binder and the disintegrant in co-granulated form.

4. A shaped body according to claim 2, wherein the shaped body comprises the bleach material and the binder in co-granulate form present in an admixture with the disintegrant.

5. A shaped body according to claim 2, wherein the body is formed by a compaction process or by injection moulding.

6. A bleach material particle according to claim 1, wherein the bleach material comprises at least one inorganic peroxide, organic peracid or chlorine based bleach including derivatives and salts thereof or mixtures thereof.

7. A bleach material particle according to claim 1, wherein the bleach material comprises at least one organic peracid.

8. A bleach material particle according to claim 7, wherein the at least one organic peracid comprises: perbenzoic acid and/or at least one peroxycarboxylic acid.

9. A bleach material particle according to claim 8, wherein the at least one peroxycarboxylic acid comprises: mono- or diperoxyphthalic acid, 2-octyldiperoxysuccinic acid, diperoxydodecanedicarboxylic acid, diperoxyazelaic acid, 6-phthalimidoperhexanoic acid or imidoperoxycarboxylic acid or derivative, salt, or mixture the derivatives and salts and mixtures thereof.

10. A bleach material particle according to claim 9, wherein the at least one peroxycarboxylic acid comprises 6-phthalimidoperhexanoic acid or derivative, salt or mixture thereof.

11. A bleach material particle according to claim 1, wherein the weight ratio of the active amount of the bleach material to the binder is in the range of from 10:1 to 1:1.

12. A bleach material particle according to claim 1, wherein the weight ratio of the active amount of the bleach material to the disintegrant is in the range of from 30:1 to 2:1.

13. A bleach material particle according to claim 1, wherein the water soluble binder has a higher degree of water solubility at 20° C. than the bleach material.

14. A bleach material particle according to claim 1, wherein the binder is an organic binder.

15. A bleach material particle according to claim 14, wherein the organic binder is a sugar based binder.

16. A bleach material particle according to claim 15, wherein the sugar based binder comprises a mixture of 6-O-a-D-Glucopyranosyl-D-sorbitol (1,6-GPS) and 1-O-a-D-Glucopyranosyl-D-mannitol dehydrate (1,1-GPM).

17. A bleach material particle according to claim 1, wherein the disintegrant is an organic material.

18. A bleach material particle according to claim 17, wherein the organic material comprises is a saccharide based material.

19. A bleach material particle according to claim 18, wherein the saccharide based material comprises a polysaccharide.

20. A bleach material particle according to claim 19, wherein the polysaccharide comprises a soy polysaccharide.

21. A detergent composition comprising the bleach material particle according to claim 1.

22. A detergent composition according to claim 21, wherein the composition is a dishwashing composition.

23. A detergent composition according to claim 22, wherein the composition is a dishwashing composition is an automatic dishwashing detergent composition.

24. A washing operation that uses a bleach material particle according to claim 1.

25. A washing operation according to claim 24 which is an automatic dishwashing operation.

26. A detergent composition comprising the shaped body according to claim 2.

27. A washing operation that uses the shaped body according to claim 2.
